(19) United States
(12) Patent Application Publication
(10) Pub. No.: US 2019/0358981 A1
(43) Pub. Date: Nov. 28, 2019

(54) REVERSE LASER WRITING AND TRANSFER PROCESS FOR DIGITAL OFFSET PRINTS

(71) Applicant: Xerox Corporation, Norwalk, CT (US)

(72) Inventors: Carolyn MOORLAG, Mississauga (CA); Marcel P. BRETON, Mississauga (CA); Edward G. ZWARTZ, Mississauga (CA); Biby Esther ABRAHAM, Mississauga (CA)

(21) Appl. No.: 15/988,108

(22) Filed: May 24, 2018

(51) Int. Cl. B41M 5/025; B41F 7/26; B41M 1/06; B41F 31/00; B41N 3/08

(52) U.S. Cl. CPC B41M 5/0256; B41F 7/26; B41N 3/08; B41F 31/005; B41M 1/06

(57) ABSTRACT

The present disclosure relates to a print process in which ink is transferred as a thin layer to a thin polymeric substrate and then the non-image areas of the polymeric substrate are laser-cured. After the curing of the non-imaged area the remaining ink (non-cured ink) undergoes complete transfer to a print-media-of-interest forming the digital print.

### BACKGROUND OF THE INVENTION

The present disclosure is related to marking and printing systems, and more specifically to variable data lithography system employing reverse laser writing.

Offset lithography is a common method of printing today. For the purpose hereof, the terms “printing” and “marking” are interchangeable. In a typical lithographic process, a printing plate, which may be a flat plate, the surface of a cylinder, belt, and the like, is formed to have “image regions” formed of hydrophobic and oleophilic material, and “non-image regions” formed of a hydrophilic material. The image regions are regions corresponding to the areas on the final print (i.e., the target substrate) that are occupied by a printing or a marking material such as ink, whereas the non-image regions are the regions corresponding to the areas on the final print that are not occupied by the marking material.

The Variable Data Lithography (also referred to as Digital Lithography or Digital Offset) printing process usually begins with a fountain solution used to dampen a silicone imaging plate on an imaging drum. The fountain solution forms a film on the silicone plate that is on the order of about one (1) micron thick. The drum rotates to an ‘exposure’ station where a high power laser imager is used to remove the fountain solution at the locations where the image pixels are to be formed. This forms a fountain solution based ‘latent image’. The drum then further rotates to a ‘development’ station where lithographic-like ink is brought into contact with the fountain solution based ‘latent image’ and ink ‘develops’ onto the places where the laser has removed the fountain solution. The ink is usually hydrophobic for better placement on the plate and substrate. An ultra violet (UV) light may be applied so that photo-initiators in the ink may partially cure the ink to prepare it for high efficiency transfer to a print media such as paper. The drum then rotates to a transfer station where the ink is transferred to a printing media such as paper. The silicone plate is compliant, so an offset blanket is not used to aid transfer. UV light may be applied to the paper with ink to fully cure the ink on the paper. The ink is on the order of one (1) micron pile height on the paper.

The formation of the image on the printing plate is usually done with imaging modules each using a linear output high power infrared (IR) laser to illuminate a digital light projector (DLP) multi-mirror array, also referred to as the “DMD” (Digital Micromirror Device). The mirror array is similar to what is commonly used in computer projectors and some televisions. The laser provides constant illumination to the mirror array. The mirror array deflects individual mirrors to form the pixels on the image plane to pixel-wise evaporate the fountain solution on the silicone plate. If a pixel is not to be turned on, the mirrors for that pixel deflect such that the laser illumination for that pixel does not hit the silicone surface but goes into a chilled light dump heat sink. A single laser and mirror array form an imaging module that provides imaging capability for approximately one (1) inch in the cross-process direction. Thus a single imaging module simultaneously images a one (1) inch by one (1) pixel line of the image for a given scan line. At the next scan line, the imaging module images the next one (1) inch by one (1) pixel line segment. By using several imaging modules, comprising several lasers and several mirror-arrays, butted together, imaging function for a very wide cross-process width is achieved.

In the aforementioned lithographic systems, it is very important to have an initial layer of dampening fluid that is of a uniform and desired thickness. To accomplish this, a form roller nip wetting system, which comprises a roller fed by a solution supply, is brought proximate the reimageable surface. Dampening fluid is then transferred from the form roller to the reimageable surface. However, such a system relies on the mechanical integrity of the form roller and the reimageable surface, the surface quality of the form roller and the reimageable surface, the rigidity of the mounting maintaining spacing between the form roller and the reimageable surface, and so on to obtain a uniform layer. Mechanical alignment errors, positional and rotational tolerances, and component wear each contribute to variation in the roller-surface spacing, resulting in deviation of the dampening fluid thickness from ideal.

For the reasons stated above, and for other reasons stated below which will become apparent to those skilled in the art upon reading and understanding the present specification, there is a need in the art for an alternative transfer process that does not require the application and removal of fountain solution thus lowering complexity and cost of prints in digital lithography print system.

### BRIEF SUMMARY OF THE INVENTION

According to aspects of the embodiments, the present disclosure relates to a print process in which ink is transferred as a thin layer to a thin polymeric substrate and then the non-image areas of the polymeric substrate are laser-cured, and the remaining ink (non-cured ink) undergoes complete transfer to a print-media-of-interest forming the digital print.

### BRIEF DESCRIPTION OF THE DRAWINGS

FIG. 1 illustrates a block diagram of a system that shows a related art ink-based digital printing system;

FIG. 2 is a side view of a system for variable lithography based on reverse laser writing and transfer process in accordance to an embodiment;

FIG. 3 is a view of optical energy and substrate interaction in a variable lithography based on reverse laser writing and transfer process in accordance to an embodiment

FIG. 4 is a flowchart of a method for reverse laser writing on an arbitrarily reimageable surface in accordance to an embodiment.

### DETAILED DESCRIPTION OF THE INVENTION

Exemplary embodiments are intended to cover all alternatives, modifications, and equivalents as may be included within the spirit and scope of the composition, apparatus and systems as described herein.

A more complete understanding of the processes and apparatuses disclosed herein can be obtained by reference to the accompanying drawings. These figures are merely schematic representations based on convenience and the ease of demonstrating the existing art and/or the present development, and are, therefore, not intended to indicate relative size and dimensions of the assemblies or components thereof. In the drawing, like reference numerals are used throughout to designate similar or identical elements.

In one aspect, a variable data lithography system, comprising an imaging member having an arbitrarily reimageable substrate (substrate); an inking subsystem for applying a thin layer of ink on the substrate; a patterning subsystem for selectively curing portions of the substrate so that at least one remaining non-cured portion forms an inked image on the substrate; and an image transfer subsystem for transferring the inked image to a print media.

In another aspect, wherein the substrate is a polymeric substrate.

In yet another aspect, wherein the substrate comprises a multilayer base having a lower contacting surface configured to wrap around a printing cylinder of the variable data lithography system.

In another aspect, wherein the polymeric substrate is selected from the group consisting of silicones, polyurethanes, butadiene rubbers, rubbers, and mixtures thereof.

In another aspect, wherein selectively curing portions of the substrate is exposing the substrate to laser radiation from a laser imaging module.

In yet a further aspect, wherein the viscosity of the ink composition is between 1.5×10⁵ centipoise and 10×10⁵ centipoise at 25° C.

In still another aspect, wherein the ink composition has a tack range of 40-60 g·m (60 s) at 45° C. and wherein the viscosity of the ink composition is between 2×10⁴ centipoise and 5×10⁴ centipoise at 45° C.

In still another aspect, further comprising: a rheology modifying agent to harden by way of exposure with ultraviolet energy the inked image on the print media and wherein thin layer of ink over the substrate is less than one micron.

In still yet a further aspect, a method for forming images in a variable data lithography system, comprising using an imaging member having an arbitrarily reimageable substrate (substrate); applying a thin layer of ink on the substrate with an inking subsystem; selectively curing, using a patterning subsystem, portions of the substrate so that at least one remaining non-cured portion forms an inked image on the substrate; transferring the inked image from the substrate to an image receiving print media; and outputting the image receiving print media with the inked imaged formed thereon from the image forming system.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The terms “dampening fluid”, “dampening solution”, and “fountain solution” generally refer to a material such as fluid that provides a change in surface energy. The solution or fluid can be a water or aqueous-based fountain solution which is generally applied in an airborne state such as by steam or by direct contact with an imaging member through a series of rollers for uniformly wetting the member with the dampening fluid. The solution or fluid can be non-aqueous consisting of, for example, silicone fluids (such as D3, D4, D5, Os10, OS20 and the like), and polyfluorinated ether or fluorinated silicone fluid.

The modifier “about” used in connection with a quantity is inclusive of the stated value and has the meaning dictated by the context (for example, it includes at least the degree of error associated with the measurement of the particular quantity). When used with a specific value, it should also be considered as disclosing that value. For example, the term “about 2” also discloses the value “2” and the range “from about 2 to about 4” also discloses the range “from 2 to 4.”

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations. The terms “first,” “second,” and the like, herein do not denote any order, quantity, or importance, but rather are used to distinguish one element from another. The terms “a” and “an” herein do not denote a limitation of quantity, but rather denote the presence of at least one of the referenced item.

The term “printing device” or “printing system” as used herein refers to a digital copier or printer, scanner, image printing machine, digital production press, document processing system, image reproduction machine, bookmaking machine, facsimile machine, multi-function machine, or the like and can include several marking engines, feed mechanism, scanning assembly as well as other print media processing units, such as paper feeders, finishers, and the like. The printing system can handle sheets, webs, marking materials, and the like. A printing system can place marks on any surface, and the like and is any machine that reads marks on input sheets; or any combination of such machines.

The term “print media” generally refers to a usually flexible, sometimes curled, physical sheet of paper, substrate, plastic, or other suitable physical print media substrate for images, whether precut or web fed.

The term “curing”, or “cure”, as used herein, refers to a change in state like fluid to solid, condition, and/or structure in a material, such as a curable ink composition that is usually, but not necessarily, induced by at least one applied variable, such as time, energy, temperature, radiation, presence and quantity in such material of a curing catalyst or curing accelerator, or the like. The term “curing” or “cured” covers partial as well as complete curing. In the occurrence of curing in any case, such as the curing of such an ink composition that has been selectively placed on a polymeric substrate or web, the components of such a composition may experience occurrence of one or more of complete or partial applied variable such as UV radiation, cross-linking or other reaction, depending upon the nature of the ink composition being cured, application variables, and presumably other factors. It is to be understood that the present invention includes inks that are not cured after application or are only partially cured after application.

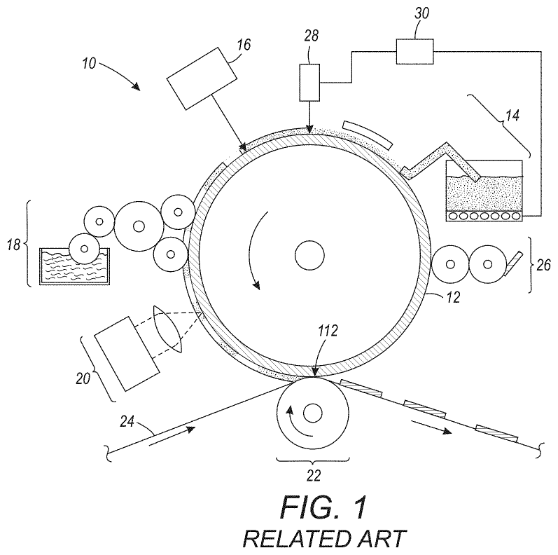

FIG. 1 shows a related art ink-based digital printing system for variable data lithography according to one embodiment of the present disclosure. System 10 comprises an imaging member 12 or arbitrarily reimageable surface since different images can be created on the surface layer, in this embodiment a blanket on a drum, but may equivalently be a plate, belt, or the like, surrounded by condensation-based dampening fluid subsystem 14, discussed in further detail below, optical patterning subsystem 16, inking subsystem 18, transfer subsystem 22 for transferring an inked image from the surface of imaging member 12 to a substrate 24, and finally surface cleaning subsystem 26. Other optional other elements include a rheology (complex viscoelastic modulus) control subsystem 20, a thickness measurement subsystem 28, control subsystem 30, etc. Many additional optional subsystems may also be employed but are beyond the scope of the present disclosure. As noted above, optical patterning subsystem 16 is complex, expensive, and accounts for the majority of total power consumption of the whole system. The imaging member 12 in the exemplary system 10 is used to apply an inked image to a target image receiving media substrate 24 at a transfer nip 112. The transfer nip 112 is produced by an impression roller at transfer subsystem 22, as part of an image transfer mechanism, exerting pressure in the direction of the imaging member 12.

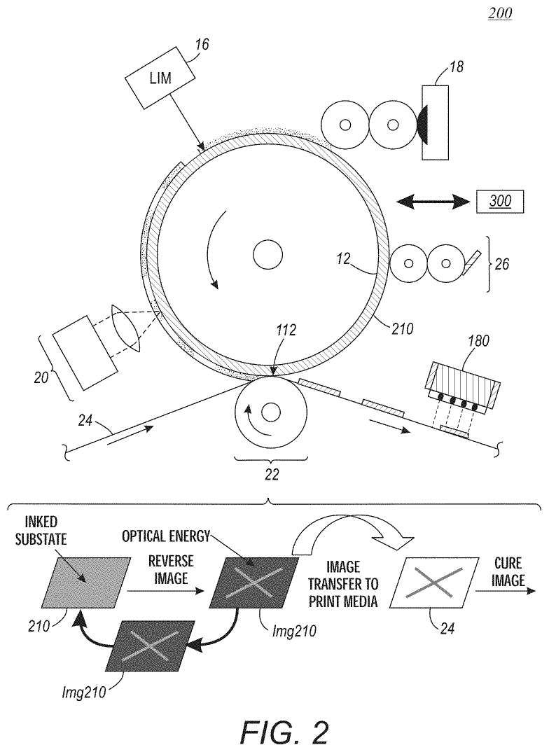

FIG. 2 is a side view of a system for variable lithography based on reverse laser writing and transfer process 200 in accordance to an embodiment. Note that portions of the system for variable lithography which are the same as those in FIG. 1 are denoted by the same reference numerals, and descriptions of the same portions as those described above with reference to FIG. 1 will be omitted.

The proposed embodiments meet the need in the art for an alternative transfer process that does not require the application and removal of fountain solution thus lowering complexity and cost of prints in digital lithography print system. For this new laser writing and transfer process, fountain solution application and evaporation steps are no longer used. The transfer blanket 12 also need not be fluorosilicone and could be any polymeric surface yielding efficient transfer of the ink.

As illustrated the dampening solution elements have been removed and the inking elements have been moved to the beginning of the process because, in the to be described process, the inking is performed before the creation of the image. Additionally, the variable lithography system is shown with a polymeric substrate (substrate) 210 that can form part of blanket 12 or can form a skirt or sheet/web riding on top of blanket 12. Ink thickness data 28 like shown in FIG. 1 and other data like percentage of ink applied within an arbitrary space may be used to provide feedback to control (controller 300) the metering of the ink applied to the polymeric substrate 210, so for the purpose of making a printable image, substrate 210 after the application of ink is effectively a tabula rasa. This slate is limited only by the curing patterns created by laser imaging system (LIM) 16.

In this newly described print process, the ink is transferred as a thin layer (<1 micron) to a thin polymeric substrate 210, then the non-image areas are cured via laser radiation (LIM 16) directly to the polymeric substrate surface. The first part of the process is referred to as the “reverse laser writing” process seeing that the ink is applied first and then the image is created on the ink. The remaining thin layer of ink upon the polymeric substrate 210 then contacts a print media 24 and undergoes complete transfer to this substrate, forming the digital print. The second part of the process is referred to as the “transfer” process. Below the illustrated structural elements of the reverse laser writing in FIG. 1 shows a schematic of the reverse laser writing and transfer process. After transferring the inked (non-cured ink) image onto the print media 24 the substrate 210 can be cleaned 26 and then ink can be re-applied so that LIM 16 can create another reverse laser writing image. Because of the durability of the surface the polymeric surface can be continuously written to with minor wear. In the case where an image is to be repeated the substrate can be re-inked in those portions that were exchanged with the print media. In the alternative, the substrate 210 can be cleaned or discarded by using another process.

The controller 300 may be embodied within devices such as a desktop computer, a laptop computer, a handheld computer, an embedded processor, a handheld communication device, or another type of computing device, or the like. The controller 300 may include a memory, a processor, input/output devices, a display and a bus. The bus may permit communication and transfer of signals among the components of the controller 300 or computing device.

Advantages of the digital print process above are high speed, high resolution, low ink consumption, and low complexity. Ink-polymeric substrate 210 interaction is a key technology factor to ensure complete image transfer especially when combined ink formulations which demonstrate a high degree of transferability from a polymeric substrate, and no ink transferred in the non-imaging areas. Ink formulations functioning for this reverse laser writing and transfer process must demonstrate viscosity and tack properties within a specified range required to achieve key print functions.

Ink properties should be within ranges as is described below. It is reasonably expected that due to the similarity of the base formulations, multiple colored formulations including cyan, magenta, yellow and black digital lithography prints would also function within the described process. Inks with properties within these ranges have been demonstrated to undergo complete transfer of ink from a low surface energy substrate under conditions of high transfer.

TABLE 1
Rheology and Tack Ranges for Inks

| | Complex | Complex | | |
|---|---|---|---|---|
| | Viscosity @ | Viscosity @ | Mean | |
| | 100 rad/s | 1 rad/s | tack from | |
| | at 45 C., | at 25 C., | 60 to 600 s, | Tack at 60 s, |
| Ink Type | mPa · s | mPa · s | g-m at 45 C. | g-m at 45 C. |
| UV Curable | 2-5E+04 | 1.5-10E+05 | 35-50 | 40-60 |
| Digital | | | | |
| Offset Ink | | | | |

To maximize ink adhesion to the print media 24, a viscosity control unit 180 positioned downstream of the ink image transfer station in the process direction increases the residual ink cohesive strength to produce a hardened residual ink. In particular, the viscosity control unit conditions the ink by curing the residual ink, to increase the residual ink cohesive strength relative to the print media. Those skilled in the art would recognize that viscosity control units within the scope of invention may include radiation curing, optical or photo curing, heat curing, drying, or various forms of chemical curing. Cooling may be used by a viscosity control unit to modify rheology as well, for example, via physical and/or chemical cooling mechanisms.

The viscosity control unit 180 shown in FIG. 2 is a UV exposure station with a UV curing lamp (e.g., standard laser, UV laser, high powered UV LED light source) that exposes the residual ink on the imaging member surface to an amount of UV light (e.g., # of photons radiation) to polymerize the ink. The level of UV light dosage sufficient to harden the residual ink may depend on several factors, such as the ink formulation (e.g., UV photo initiator type, concentration), UV lamp spectrum, printer processing speed and amount of residual ink on the imaging member 110 surface. While not being limited to a particular range, for an exemplary UV curing lamp (e.g., about 395 nm LED), the inventors through extensive experimentation found that a range of UV light photons from about 30 mJ/cm2 to 600 mJ/cm2 may sufficiently increase the viscosity of the residual ink on the imaging member surface for subsequent removal.

Applications of this Reverse Laser Writing and Transfer Process include: digital offset printing of 2D prints, digital masks, or digital printing of any functional ink onto a surface (such as special effects material, or an adhesive layer).

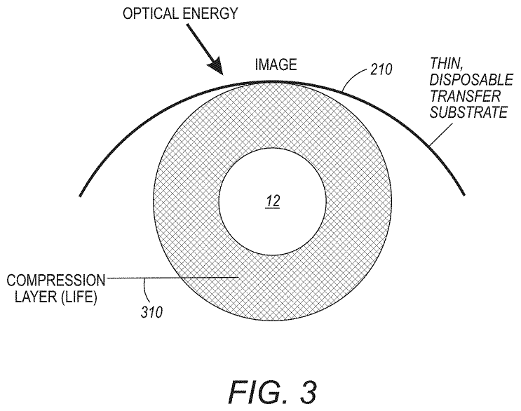

FIG. 3 is a view of optical energy and substrate interaction in a variable lithography based on reverse laser writing and transfer process in accordance to an embodiment. Note that portions of the system for variable lithography which are the same as those in FIG. 1 and FIG. 2 are denoted by the same reference numerals, and descriptions of the same portions as those described above with reference to FIG. 1 and FIG. 2 will be omitted. FIG. 3 demonstrates image transfer of ink such as white ink to a substrate 210 like black paper. When insufficient optical energy (power) is used to cure the non-image areas, some ink transfer occurred resulting in a weak image. However, t using higher optical energy (power) results in a high contrast image, where only ink transfers in the image area by compressing the substrate 210 at nip 112 as described with reference to FIGS. 1 and 2. The transferred ink was subsequently cured using viscosity control unit 180. Example transfer surfaces (substrate 210) for optimal transfer are: Silicones, Polyurethanes, Filled Silicones, Butadiene Rubbers, Isoprene Rubbers, EDMP Rubbers, and Fluorosilicone Rubbers.

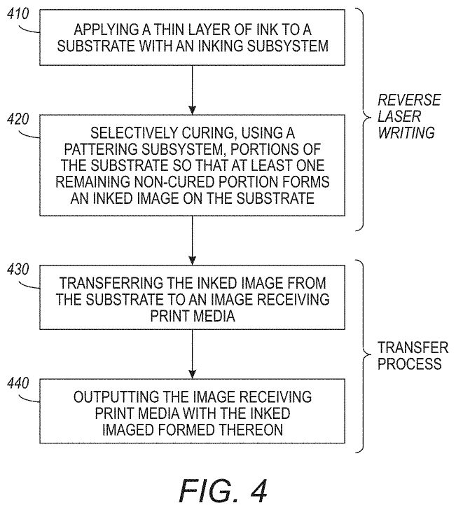

FIG. 4 is a flowchart of a method 400 for reverse laser writing on an arbitrarily reimageable surface in accordance to an embodiment. The method 400 comprises two parts the first part of the process (action 410 and 420) is referred to as the “reverse laser writing” process and the second part of the process is referred to as the “transfer” process.

The first part begins with action 410 where a thin layer of ink is applied with inking subsystem 18 to a thin polymeric substrate like substrate 210; and then in action 420, selectively curing, using a patterning subsystem such as LIM 16, portions of the substrate 210 so that at least one remaining non-cured portion forms an inked image on the substrate 210. After applying ink to the substrate and curing portions of the substrate so as to hardened and prevent transfer the substrate is moved to the transfer process like transfer subsystem 22 shown in FIG. 2. The transfer process begins with action 430 where the inked substrate and a print media 24 are pressed against the rollers of transfer subsystem 22 so that the non-cured portions of the inked media are transferred to the media. The method continues to action 440 where an image receiving print media is produced after the pressing of the substrate and the media at nip 122. The produced print media with the image can then irradiated with optical energy to maintain a cured image thereon.

It will be appreciated that various of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A variable data lithography system, comprising:
an imaging member having a substrate;
an inking subsystem for applying a thin layer of ink on the substrate;
a patterning subsystem for selectively curing portions of the substrate so that at least one remaining non-cured portion forms an inked image on the substrate; and
an image transfer subsystem for transferring the non-cured inked image to a print media.

2. The variable data lithography system of claim 1, wherein the substrate is a polymeric substrate.

3. The variable data lithography system of claim 2, wherein the substrate comprises a multilayer base having a lower contacting surface configured to wrap around a printing cylinder of the variable data lithography system.

4. The variable data lithography system of claim 3, wherein the polymeric substrate is selected from the group consisting of silicones, polyurethanes, butadiene rubbers, rubbers, and mixtures thereof.

5. The variable data lithography system of claim 2, wherein selectively curing portions of the substrate is exposing the substrate to laser radiation from a laser imaging module.

6. The variable data lithography system of claim 5, wherein the viscosity of the ink composition is between 1.5×10⁵ centipoise and 10×10⁵ centipoise prior to curing.

7. The variable data lithography system of claim 6, wherein the ink composition has a tack range of 40-60 g·m (60 s) at 45° C.

8. The variable data lithography system of claim 7, wherein the viscosity of the ink composition is between 2×10⁴ centipoise and 5×10⁴ centipoise at 45° C.

9. The variable data lithography system of claim 5, wherein thin layer of ink over the substrate is less than one micron.

10. The variable data lithography system of claim 9, further comprising:
a rheology modifying agent to harden by way of exposure with ultraviolet energy the inked image on the print media.

11. A method for forming images in a variable data lithography system, comprising:
using an imaging member having a substrate;
applying a thin layer of ink on the substrate with an inking subsystem;
selectively curing, using a patterning subsystem, portions of the thin layer of ink on the substrate so that at least one remaining non-cured portion forms an inked image on the substrate;
transferring the inked image from the substrate to an image receiving print media; and
outputting the image receiving print media with the inked imaged formed thereon from the image forming system.

12. The method of claim 11, wherein the substrate is a polymeric substrate.

13. The method of claim 12, wherein the substrate comprises a multilayer base having a lower contacting surface configured to wrap around a printing cylinder of the method.

14. The method of claim 13, wherein the polymeric substrate is selected from the group consisting of silicones, polyurethanes, butadiene rubbers, rubbers, and mixtures thereof.

15. The method of claim 12, wherein selectively curing portions of the thin layer of ink on the substrate is exposing the substrate to laser radiation from a laser imaging module.

16. The method of claim 15, wherein the viscosity of the ink composition is between 1.5×10⁵ centipoise and 10×10⁵ centipoise prior to curing.

17. The method of claim 16, wherein the ink composition has a tack range of 40 to 60 g·m (60 s) at 45° C.

18. The method of claim 17, wherein the viscosity of the ink composition is between 2×10⁴ centipoise and 5×10⁴ centipoise at 45° C.

19. The method of claim 15, wherein thin layer of ink over the substrate is less than one micron.

20. The method of claim 19, further comprising:
a rheology modifying agent to harden by way of exposure with ultraviolet energy the inked image on the print media.
